(19) United States
(12) Patent Application Publication
(10) Pub. No.: US 2009/0028999 A1
(43) Pub. Date: Jan. 29, 2009

(54) Beer brewing kit and brewing method to prepare wort for the kit

(76) Inventors: Klaus U. Melisch, Caledon (CA); Stefan Riedelsheimer, Caledon (CA)

Correspondence Address: Eric Fincham, 316 Knowlton Road, Lac Brome, Quebec, J0E 1V0, CA

(21) Appl. No.: 11/881,533

(22) Filed: Jul. 27, 2007

(51) Int. Cl. C12C 13/10; C12C 11/00

(52) U.S. Cl. 426/8

(57) ABSTRACT

A kit for home brewed beer which comprises a bottle, wort substantially filling the bottle, and a cap which has venting means to permit escape of gas from the bottle when pressure therein exceeds a predetermined value. There is also disclosed a brewing method wherein lactic acid is added to the wort to reduce the pH to level 4.6 and a predetermined amount of yeast is added to the wort to cause a short fermentation while maintaining the alcohol level below 0.5% by volume.

### FIELD OF THE INVENTION

The present invention relates to brewing and more particularly, relates to the brewing of beer within a bottle.

### BACKGROUND OF THE INVENTION

Home brewing of alcoholic beverages has become more and more prevalent as time goes on. The home brewing of beer is a long established and well-known art. Frequently, the brewing of the beer is a replication of a commercial brewing process. However, the equipment required is substantial as well as requiring a great deal of time.

The traditional home brewer will often use a wort pot and a bucket fermenter with a gasketed lid and a fitting for a water filled fermentation lock. Other equipment includes a bottling bucket, bottling siphon, hydrometer, wort chiller, bucket brush and sanitizing chemicals so that all the apparatus can be sanitized before use. Careful sanitizing is always necessary to make good beer and to prevent spoiling of the same. Thus, microbes present in the environment may get into the wort and grow along with the worting yeast.

There are known machines that brew an unfermented beer (wort) from the raw materials, malt and hops. These machines are also capable of fermenting the wort into a flat beer. However, the beer is not carbonated and in order to do so, the consumer has to transfer the fermented beer into other containers and then add fermentable sugar to create carbonation.

While careful attention to details will produce a drinkable product, many enthusiasts do not wish to undertake the careful control of the environment in order to brew beer.

### SUMMARY OF THE INVENTION

It is an object of the present invention to provide a kit suitable for home brewing of beer.

It is a further object of the present invention to provide a method for the preparation of a wort suitable for home brewing.

It is a further object of the present invention to provide a method of home brewing from a kit.

According to one aspect of the present invention, there is provided a kit for home brewed beer comprising a bottle, wort substantially filling the bottle, and a cap, the cap having venting means to permit escape of gas from the bottle when pressure therein exceeds a predetermined value.

According to a further aspect of the present invention, there is provided a brewing method comprising the steps of preparing a wort, adding lactic acid to the wort while heating the wort to reduce the pH of the wort to below 4.6, adding a predetermined amount of yeast to the wort to cause a short fermentation while maintaining the alcohol content below 0.5% by volume, packaging the wort in a container, and sealing the container.

There is also provided a home brewing method wherein the above mentioned container has yeast added thereto, and the temperature of the container is maintained above 19° C. for a period of time sufficient to permit complete fermentation, and the product subsequently refrigerated.

According to one aspect of the present invention, the kit, as aforementioned, comprises a bottle, wort substantially filling the bottle and a cap which has venting means to permit escape of gas from the container when pressure therein exceeds a predetermined value.

In the preferred embodiment, the container is a bottle and may conveniently be formed a PET material as is well known in the art. The wort, which is a pasteurized unfermented beer substantially fills the bottle. The consumer, upon purchase, opens the bottle and drops in a capsule containing yeast. Subsequently, the cap is screwed on and after about 10 days, the wort will ferment into a beer containing approximately 5% alcohol by volume.

The cap has, as aforementioned, venting means to permit the release of some carbon dioxide which is a natural by-product of fermentation. This release ensures that the bottle will not explode, but keeps enough pressure in the bottle to naturally carbonate the beer. At the end of the fermentation period, the yeast will settle down to the bottom as firm sediment.

The venting means could include various types of venting valves and the like. However, in a preferred embodiment, a standard screw-on plastic cap is provided with an aperture extending therethrough. The aperture may conveniently be in the range of 6 to 14 ml with a preferred size of approximately 10 ml.

Underneath the cap, there is a disc which has a very small opening therein. Conveniently, the disc may be made of a silicon material and have a thickness in the range of 1.5 ml. The opening in the round silicon flat disc may be made by a needle which provides sufficient opening for pressure release.

For shipping purposes, the container filled with the wort may have a conventional plastic cap with a second apertured cap being provided. After the beer has fermented, the normal cap (used for shipping) may be reapplied. In preparing the wort, conventional materials and techniques may be utilized. However, since the wort has a pH of approximately 5.2, it either must be kept refrigerated or the pH lowered to a level where pathogenic bacteria cannot survive. Thus, in the preferred embodiment, a small amount of lactic acid is added during boiling of the wort to help lower the pH to a desired level. Preferably, very soft water is used to make the wort.

Subsequent to the above, a small quantity of yeast may be added and the wort fermented for a short time. During fermentation, the pH lowers naturally. It is also important that the alcohol level be maintained below 0.5% by volume.

As aforementioned, once the consumer purchases the product, it is only necessary to attach the apertured cap and membrane after inserting a yeast capsule.

Preferably the packaged wort (and final beer product) uses a container which has a capacity of approximately two litres. The bottle may be a standard PET bottle. The pH of the wort, as shipped, is preferably 4.6 or lower. At this pH, the problem of pathogenic bacteria is avoided.

The yeast is preferably provided in the form of a pill which dissolves in the wort. This provides for a very convenient shipping arrangement and also simplifies the addition of the yeast to the wort by the user.

As aforementioned, the cap may be utilized with a disc made of a silicon material. Alternatively, the cap could be injection molded with the silicon membrane. The silicon membrane could be exchanged for other suitable materials such as synthetic rubbers made of polymeric material which acts as an elastomer. An example of such a material is Bunan or Nytrial which is a copolymer of Butadiene and Acrylonytral. The consumer, after adding the yeast to the wort, maintains the container at a temperature sufficiently high to permit complete fermentation and the consumer will then subsequently refrigerate the product. Normally, a temperature above 19° is suitable though different yeasts may allow for different fermentation temperatures.

### BRIEF DESCRIPTION OF THE DRAWINGS

Having thus generally described the invention, reference will be made to the accompanying drawings illustrating an embodiment thereof, in which:

FIG. 1 is a perspective side view of the neck of a container along with the membrane and apertured cap;

FIG. 2 is a cross-sectional view through the cap and membrane when placed on top of the bottle; and

FIG. 3 is a cross-sectional view illustrating venting of the container during fermentation.

### DETAILED DESCRIPTION OF THE INVENTION

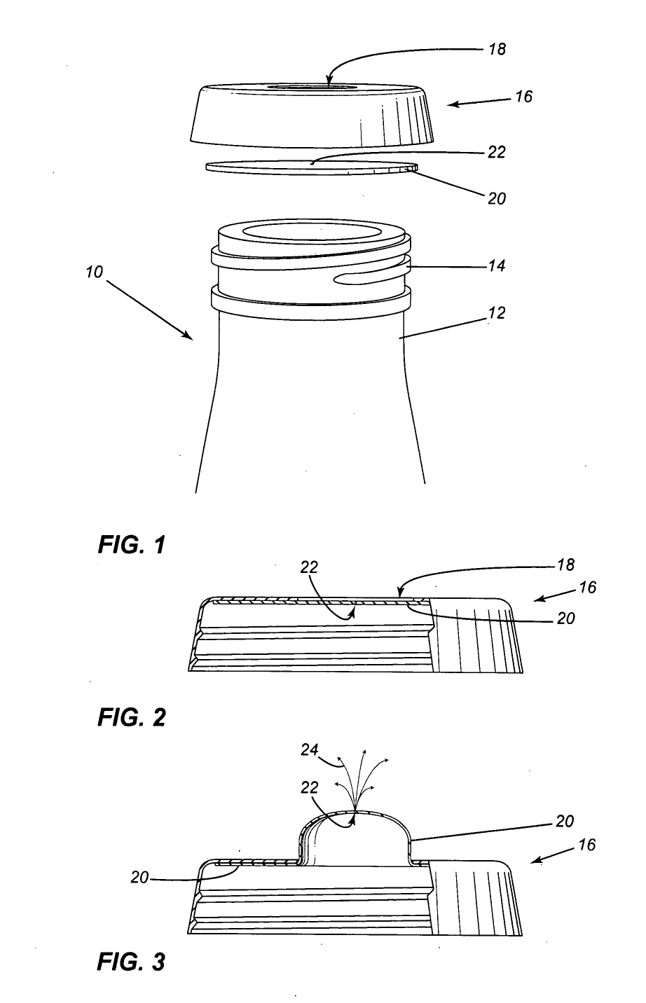

Referring to the drawings in greater detail and by reference characters thereto, there is illustrated in FIG. 1 a portion of a bottle 10 having a neck 12. Screw threads 14 are provided on the exterior portion of neck 12.

The apertured cap of the present invention is designated by reference numeral 16 and has opening 18 therein. A membrane 20 is provided and has an aperture 22 therein which is preferably formed by pricking the membrane with a needle.

As shown in FIG. 2, the membrane 20 seals opening 18. During fermentation, as shown in FIG. 3, membrane 20 will bulge upwardly slightly while, as indicated by arrows 24, carbon dioxide formed during fermentation may escape through aperture 22.

It will be understood that the above described embodiment is for purposes of illustration only and changes and modifications may be made thereto without departing from the spirit and scope of the invention.

We claim:

1. A kit for home brewed beer comprising:
a bottle;
wort substantially filling said bottle, said wort having a pH below 4.6; and
a cap, said cap having venting means to permit escape of gas from said bottle when pressure therein exceeds a predetermined value.

2. The kit of claim 1 wherein said bottle is formed of a plastic material.

3. The kit of claim 2 wherein said venting means comprises an aperture in said cap, a membrane covering said aperture.

4. The kit of claim 3 wherein said membrane comprises a silicon membrane having a small aperture formed therein to permit venting.

5. The kit of claim 1 wherein said kit further includes a second cap, said second cap being designed to be secured to said bottle for transport.

6. The kit of claim 1 further including a yeast pill.

7. The kit of claim 5 wherein said caps are screw threadedly engaged with said bottle.

8. A brewing method comprising the steps of:
preparing a wort;
adding lactic acid to said wort while heating said wort to reduce the pH of said wort;
adding a predetermined amount of yeast to said wort to cause a short fermentation while maintaining the alcohol content below 0.5% by volume and reducing the pH to below 4.6;
packaging said wort in a container; and
sealing said container.

9. The method of claim 8 wherein the steps of preparing said wort comprises using soft water.

10. The method of claim 9 wherein said step of packaging said wort comprises packaging the wort in a plastic bottle and screw threadedly sealing said container.

11. A home brewing method comprising the steps of taking a bottled product of claim 7, adding yeast to said wort, maintaining said container at a temperature above 19° C. for a period of time sufficient to permit complete fermentation, and subsequently refrigerating said product.
